(19) United States
(12) Patent Application Publication
(10) Pub. No.: US 2009/0185367 A1
(43) Pub. Date: Jul. 23, 2009

(54) Water resistant flashlight with integral hidden storage

(76) Inventors: William Ronald Moore, Brighton, MI (US); Ethan Dean, Pinckney, MI (US); Troy D. Pryor, Davison, MI (US)

Correspondence Address: WILLIAM RONALD MOORE, 7288 GOLDENROD COURT, BRIGHTON, MI, 48116, US

(21) Appl. No.: 12/319,289

(22) Filed: Jan. 6, 2009

Related U.S. Application Data
(60) Provisional application No. 61/010,395, filed on Jan. 8, 2008.

(51) Int. Cl. F21V 31/00

(52) U.S. Cl. 362/158

(57) ABSTRACT

A water resistant flashlight with integral hidden storage is provided in combination is intended for secretiveness in any situation where someone has something they wish to be concealed. The handle end cap and light housing are interconnected by mechanical means with a light source disposed in the light housing. The on off switch and power source are also disposed in the handle, end cap and battery housing. The hidden storage is located in the handle.

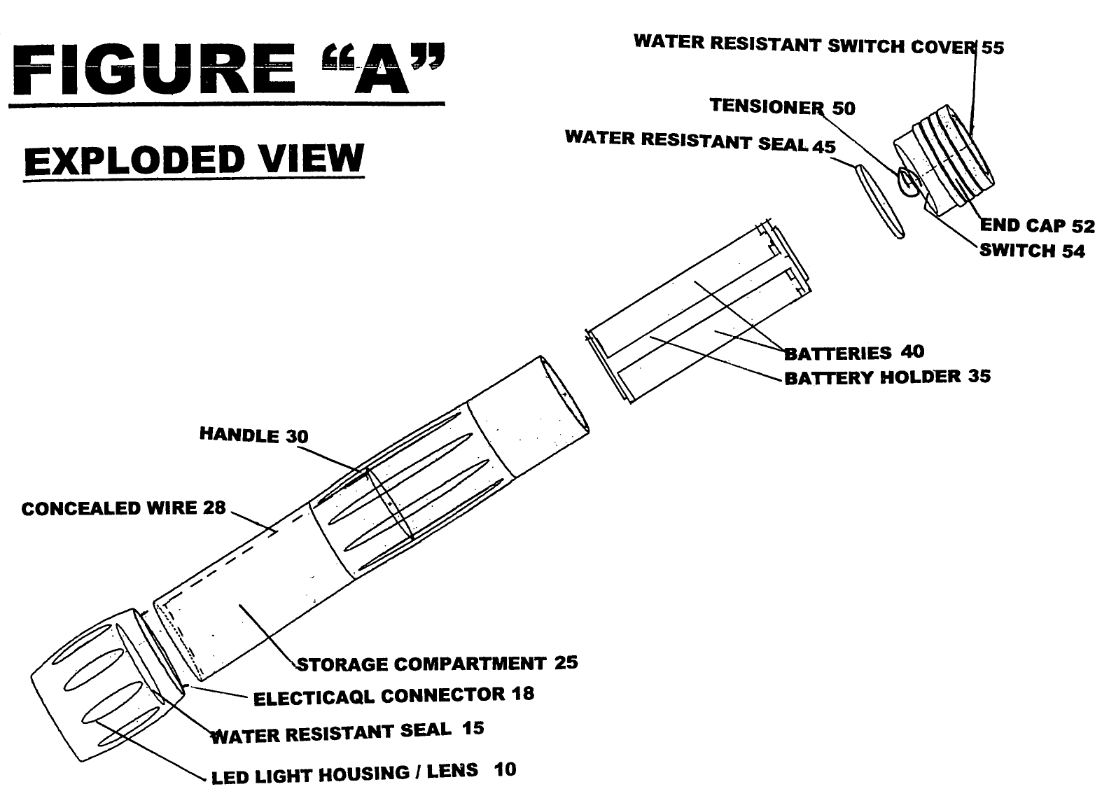

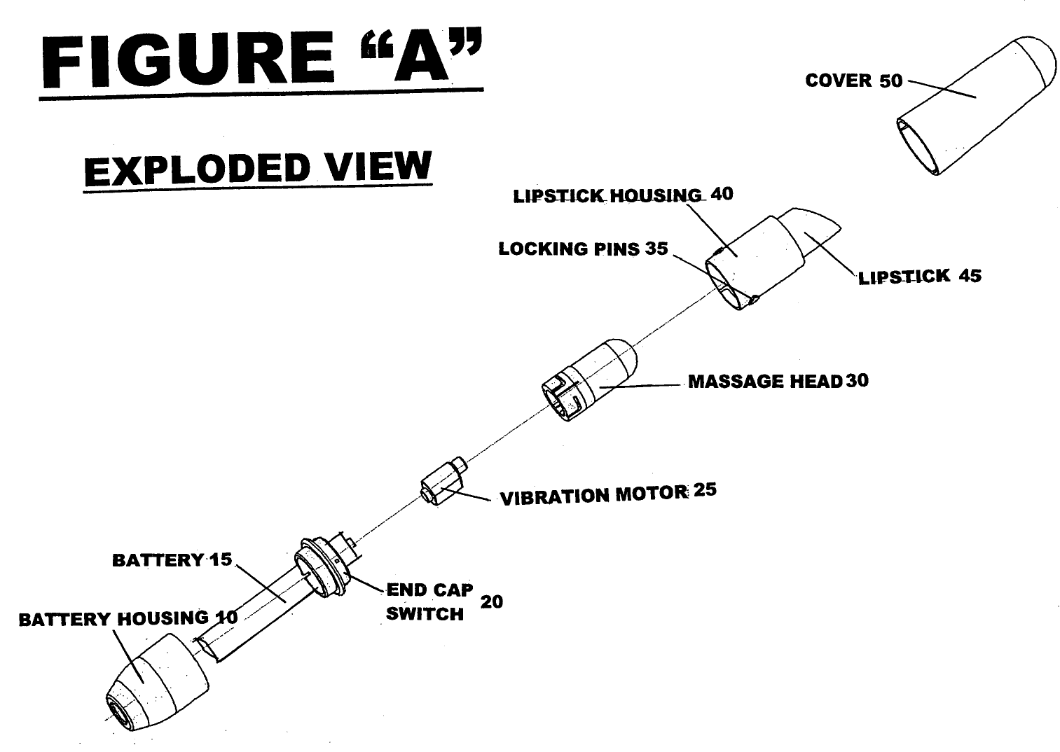

### CROSS-REFERENCE TO RELATED APPLICATIONS

This application claims the benefit of provisional patent application Ser. No. 61/010,395, filed Jan. 8, 2008 by the present inventors.

### FEDERALLY SPONSORED RESEARCH

Not Applicable

### SEQUENCE LISTING OR PROGRAM

Not Applicable

### BACKGROUND

1. Field

This application relates to flashlights, water resistant or not combined with a hidden storage compartment.

2. Prior Art

Flashlights and water resistant flashlights have been available for some time in the market place. Our invention is unique from existing products in that it combines a flashlight with a completely hidden storage compartment accessible by the use of left hand threads, not commonly used or recognized by the average consumer. Our invention is also superior to existing product by locating the power source away from the light bulb and running the power wires through the storage area. The use of a battery pack allows us to provide increased battery power and a wide variety of voltages. Our flashlight is water resistant along with the storage compartment.

### SUMMARY

One embodiment is a battery powered flashlight with a totally concealed storage compartment. The embodiment is also water resistant for out door use.

### DRAWINGS

### FIG. “A”

FIG. “A” shows the invention in a blown up drawing, showing all of the parts and their interrelationship to each other.

### DRAWINGS

### Reference Numerals

10 LED light housing and lens
15 water resistant seat
18 electrical connector
25 storage compartment
28 concealed wire
30 handle
35 battery holder
40 batteries
45 water resistant seal
50 tensioner
52 end cap
54 switch
55 water resistant switch cover

### DETAILED DESCRIPTION

### FIG. “A”

One embodiment of the water resistant flashlight with integral hidden storage is illustrated in FIG. “A” (exploded view). The flashlight storage combination starts with a water resistant switch cover 55 mounted to the end cap 52 over the switch 54. The switch is the attached to a tensioner 50 which tightens the battery holder 35. The battery holder is currently designed to hold 3 AAA batteries. Numerous configurations of this set up are possible to create more or less power, more or less batteries, and many types of connection systems are available.

The battery holder 35 is put into the handle 30 and held in place by the end cap 52. The power from the battery holder 35 is then transferred through the storage compartment via a concealed wire 28 and a 360 degree electrical connector 18 to the LED light housing 10, after the housing is attached to the handle 30 using left hand threads. A water resistant seal 15 is placed between the handle 30 and the LED light housing 10. The LED light housing could vary in terms of size and power. The water resistant seal could be made in many ways, o rings, threads, caulk for example. The method of attachment could also vary using threads, slots or snap fittings for example. The handle could be made of many different materials, metal, plastic or other and be of any size or shape. The bulbs do not have to be LED, but could be incandescent, halogen or other.

The manner of use of the water resistant flashlight with integral hidden storage as a flashlight is straight forward. First remove the end cap 52 and insert batteries 40 into the battery holder 35. Replace the battery holder 35 into the handle 30 and secure by attaching the end cap 52 onto the handle. Activate the light by pressing on switch 54 through the switch cover 55, this turns the light on and off.

To access the hidden storage compartment 25 remove the LED light housing 10 from the handle 30, the method of removal may not be easily ascertained. The use of left hand threads or other hidden releases insure the security of the compartment. Place into the hidden storage compartment 25 whatever one wishes and reattach the LED light housing 10 to the handle 30.

### ADVANTAGES

The combination of hidden storage compartment in a fully functional flashlight using left hand threads and with electrical connectivity through the storage compartment is unique. No other product like it is found in the marketplace. By combining a hidden storage compartment with a flashlight owners are able to secret their valuables while they travel with little risk of discovery. In any environment the product may be left in plain view. Water resistant means it can be used indoors, outdoors, in any wet location. LED lighting means you can get a bright fully functional light out of a smaller flashlight. It is a truly multifunctional battery powered device that allows one to also hide and secure their valuables from others.

### CONCLUSIONS, RAMIFICATIONS AND SCOPE

Numerous variations present themselves in the construction of this water resistant flashlight with integral hidden storage. The housing handle and cap could be made of a variety of materials, plastic, aluminum, or steel as examples. The size and shape of the housing, handle and cap could be altered as well as the color. The light housing, lens and bulbs could vary in size, voltage and shape. Batteries could be substituted of different voltages. The method of making it water resistant could be rubber o rings, gaskets, caulk, or any other method. The method of connecting the housing, caps and handle could vary by using slots and pins, threaded, snap fittings or other. The switch could be variable or multiple position.

Although the description above contains many specifics, these should not be construed as limiting the scope of the embodiments but as merely providing some illustration of the currently preferred embodiments. Thus the scope of the embodiments should be determined by the appended claims and their legal equivalents, rather then the examples given.

We claim:

1. A hand held flashlight with storage compartment, comprising in combination:
a housing having a first and second portions interconnected by a mechanical means;

2. The hand held flashlight with storage compartment as defined in claim 1, further including a switch mounted in the end cap of said first portion of said housing.

3. The hand held flashlight with storage compartment as defined in claim 1, further including a battery pack that is removable and mounted inside said first portion of said housing for providing power to the light bulbs.

4. The hand held flashlight with storage compartment as defined in claim 1, further including a battery pack that is isolated from said second portion.

5. The hand held flashlight with storage compartment as defined in claim 1, further including a detachable second portion.

6. The hand held flashlight with storage compartment as defined in claim 1, further including multiple optional attachable second portions.

7. The hand held flashlight with storage compartment as defined in claim 1, further including rubber seals that insure a waterproof seal of said first and second portions.

8. The hand held flashlight with storage compartment as defined in claim 7, wherein said detachable first portion there is an insulated power lead between the outer case of the handle and the storage compartment to provide power to said second portion.

9. The hand held flashlight with storage compartment has a removable second portion to access said storage compartment.

10. The hand held flashlight with storage compartment as defined in claim 9, wherein said detachable second portion from the first portion is by the use of left hand threads.

11. A method of disguising a storage compartment in a fully functional flashlight

12. A method of accessing a storage compartment in a fully functional flashlight comprising the steps of removing said second portion from said first portion.

13. A method of connecting and disconnecting said first portion from said second portion by the use of left hand threads.

14. A method of providing a supply of power from said first portion to said second section through a storage compartment in a fully functional flashlight.
